(19) United States
(12) Patent Application Publication
(10) Pub. No.: US 2017/0004442 A1
(43) Pub. Date: Jan. 5, 2017

(54) SYSTEM AND METHOD FOR INVENTORY AND SUPPLY CHAIN MANAGEMENT

(71) Applicant: Ortho Solutions, LLC, Ellensburg, WA (US)

(72) Inventors: Garth Luke, Ellensburg, WA (US); Carbon Argo, Carbonado, WA (US)

(21) Appl. No.: 14/819,928

(22) Filed: Aug. 6, 2015

Related U.S. Application Data
(60) Provisional application No. 62/033,977, filed on Aug. 6, 2014.

(51) Int. Cl. G06Q 10/08; G06K 7/10

(52) U.S. Cl. CPC G06Q 10/087; G06K 7/10009; G06K 7/10544

(57) ABSTRACT

A web based system and process reads and combines data from an RFID tag with a supplementary or existing product identification (ID) marker into a comprehensive central data base. Information in the database provides near real time inventory management, optimization of operational performance, objective analysis of operational metrics for improved financial results and enterprise value, and decreases negative impacts and cost associated with purchase, installation and adoption of a new operating system.

### PRIORITY CLAIM

The present application claims the benefit of U.S. Provisional Patent Application No. 62/033,977 filed on Aug. 6, 2014. The foregoing application is hereby incorporated in its entirety as if fully set forth herein.

### FIELD OF THE INVENTION

This application relates generally to systems and methodology for inventory and supply chain management.

### BACKGROUND OF THE INVENTION

Inventory and supply chain management is increasingly important to the overall health and success of business. As the complexity of the business increases, so too does the complexity of the business' supply chain and inventory control issues. This is particularly true, for example, for distributors, who receive products from multiple vendors and supply product to multiple customers. The distributors stock products from various vendors to meet the needs of its customers. Each vendor typically has their own method of product identification, making it difficult to combine the information into one central data base, and the distributor cannot realistically run multiple operating systems to accommodate the different vendors' systems. In addition, the portfolio of products and vendors constantly change and the integration or creation of a custom operating system is cost prohibitive. Accordingly, there is a need for a system and process that allows effective supply chain and inventory management, optimization of operational performance and improved financial metrics.

### SUMMARY OF THE INVENTION

A system and process reads and combines data from an RFID tag with a supplementary or existing product identification (ID) marker into a comprehensive central data base. Information in the database provides near real time inventory management, optimization of operational performance, objective analysis of operational metrics for improved financial results and enterprise value.

### BRIEF DESCRIPTION OF THE DRAWINGS

Preferred and alternative examples of the present invention are described in detail below with reference to the following drawings:

FIG. 1 is a flow chart of a process according to a preferred embodiment of the invention;

FIG. 2 is a schematic diagram of a system and process according to a preferred embodiment of the invention;

FIG. 3 is a schematic diagram illustrating order and set-up aspects of a system and process according to a preferred embodiment of the invention; and,

FIG. 4 illustrates the association of an RFID tag with ID markers according to a preferred embodiment of the invention.

### DETAILED DESCRIPTION OF THE PREFERRED EMBODIMENT

This patent application describes one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be operational with numerous general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

This specification discusses a systems and methodology for inventory and supply chain management. In accordance with a preferred embodiment, as will be discussed more fully below, a web based system and process reads and combines data from an RFID tag with a supplementary or existing product identification (ID) marker (such as, for example, bar codes, SKUs, serial numbers, or quick response (QR) tags) into a comprehensive central data base. Information in the database provides near real time inventory management, optimization of operational performance, objective analysis of operational metrics for improved financial results and enterprise value, and decreases negative impacts and cost associated with purchase, installation and adoption of a new operating system.

The systems and process according to an embodiment of the invention provides users with virtual and real time visibility of product location, visibility when items are transferred from one location to another, decreased product loss, the ability to objectively monitor/improve product turns, par levels, tracking of items for recalls, product upgrades, or warranties, identify product aging to escalate sales, decrease dead stock, and improve cost of goods, deceased manual inventory analytics (i.e. hand counts) for real time inventory management, improvement of operational/manufacturing supply chain management, accurate and reliable reporting, optimized labor resources and decreased product carrying cost.

The system and process preferably utilize uncoded RFID tags that may then be populated (encoded) with information from the supplemental or existing product indentification markers. This allows the use of off-the-shelf RFID tags instead of custom tags, thereby reducing implementation costs and further extending the applicability of the system and process.

One example of a supply chain and inventory system that would benefit from the system and process of the present invention is a medical supply distributor, specifically, and orthopedic supply distributor. Typically, the distributor places product in an orthopedic office or clinic to be used for patient management and care. This is typically a consignment process. Once an item or product is provided to a patient, demographics and insurance information is collected and provided to the distributor for billing purposes. When the billing information is received, the distributor replaces the product in the clinic. To monitor product movement, inventory levels, product loss or shrinkage (theft), and product preference/usage, a sales or service representatives does a visual count at specified times (for example, once a week or once a month) depending upon the volume and size of the clinic.

These distributors are negatively impacted by discrepancies between inventory levels and billing information provided to the distributor, inability to track transfers, objective analysis of product usage, par levels, and product optimization, lost profits through delayed return of paperwork for timely billing, and no visibility of products provided free of cost. In addition this inventory management process does not provide real time reporting to improve turns, decrease carrying cost, provide objective information to set par levels, and identify of dead or slow moving product.

A preferred embodiment of the present invention is discussed next by way of an example, and more specifically, in terms of orthopedic supply distribution, introduced previously. By combining RFID technology with existing ID markers/operating systems into a comprehensive business management system, many of the foregoing issues are resolved through improved supply chain/inventory management, virtual near-real time business intelligence, accurate reporting, and optimization of business management. While the example of orthopedic supply distribution is discussed herein, it is understood that orthopedic supply distribution is merely one example and that other businesses and operations with supply chain and inventory management needs may use the system and process of the present invention.

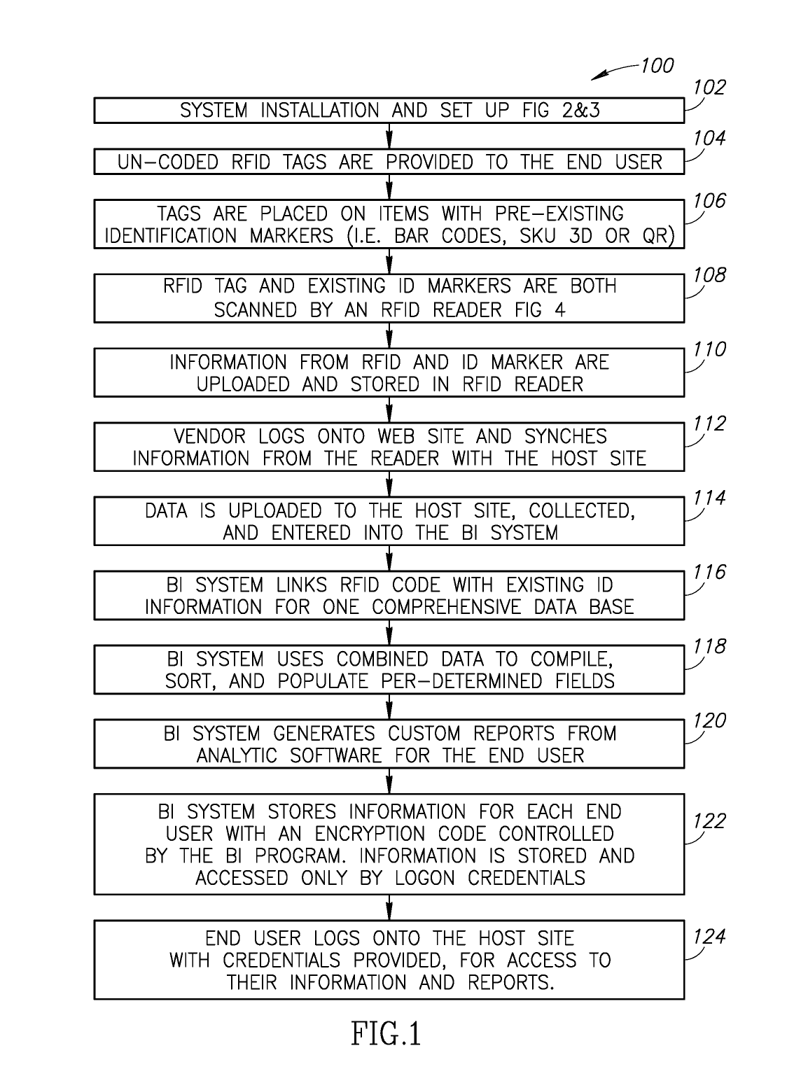

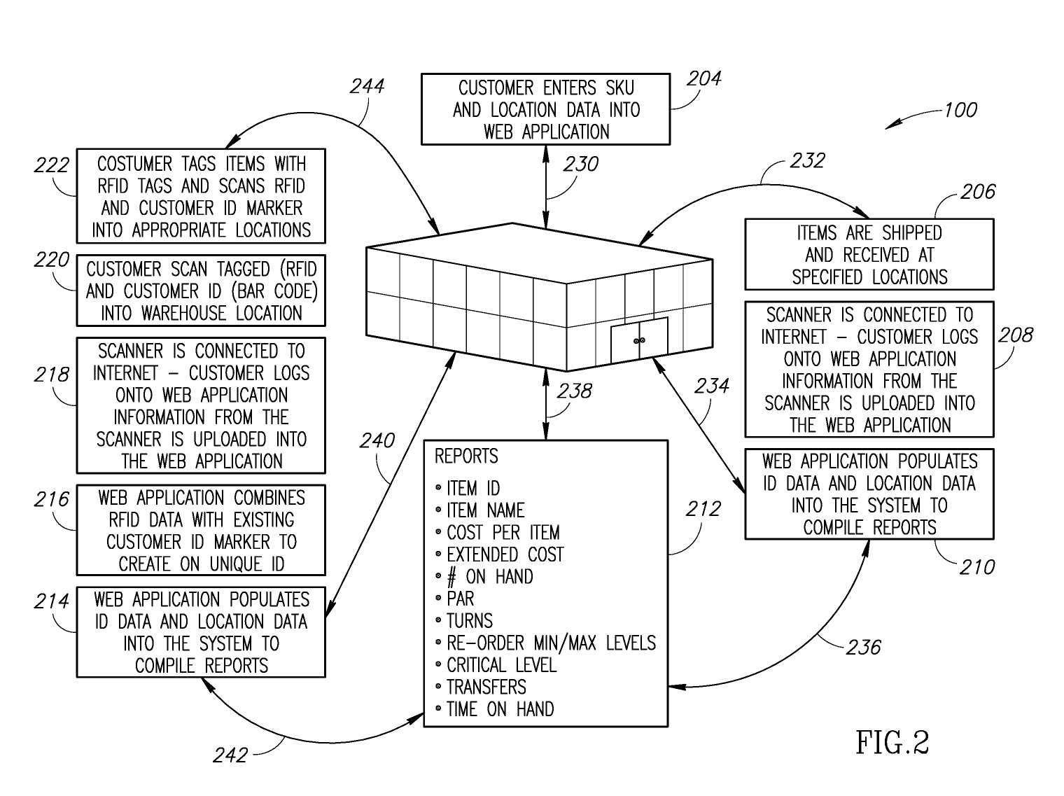

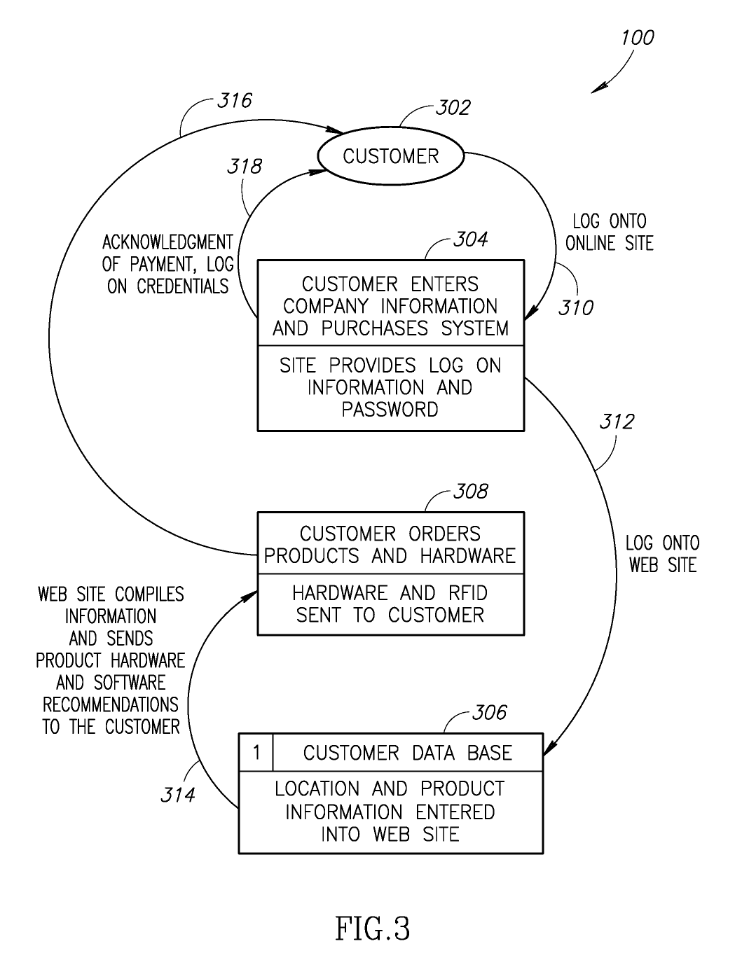

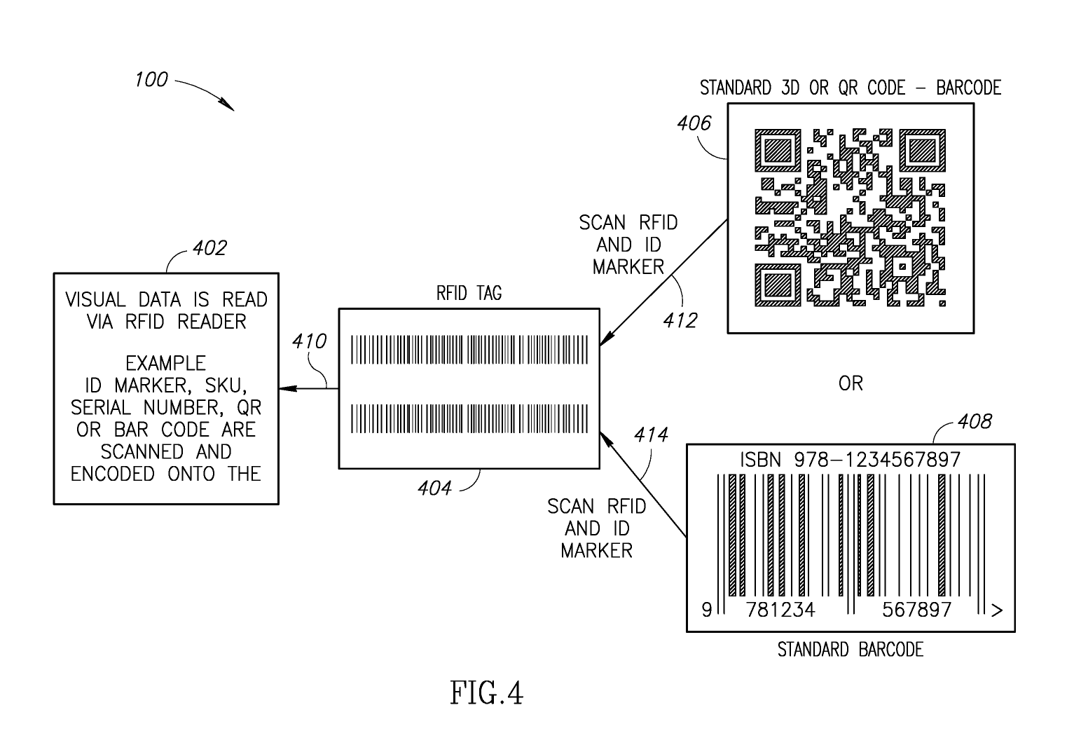

FIGS. 1-4 illustrate aspects of a supply chain and inventory management system and process 100 for an orthopedic supply distributor in accordance with one embodiment of the present invention. Turning to FIG. 1, at step 102, a system 100 according to the present invention is installed and set up (see also FIGS. 2 and 3). Once step 102 is completed, uncoded RFID tags are provided by the distributor to a supplier/vendor at step 104. At step 106 the tags are placed on products with pre-existing ID markers (such as a bar code or QR tag). At step 108, RFID tags and product ID markers are scanned by an RFID reader (see also FIG. 4). For example, tagged products may be placed in warehouse locations and scanned by a centralized RFID reader in the wharehouse programmed to accept both sets of information. At step 110, the scanned information from an RFID tag and ID marker are uploaded and stored in an RFID reader. At step 112, the supplier/vendor logs onto a secure website and the RFID reader is synced with a host site and at step 114 information is uploaded to the host site, collected and entered into the business management (BI) system. In step 116, the BI system links uploaded data (RFID code and existing ID information) and combines the uploaded data into one unique ID marker in one comprehensive data base. At step 118, the BI system uses the combined data to compile, sort and populate predetermined fields. Each RFID tag is unique allowing each item to be tracked. For example, the unique RFID tag allows the user to determine how long an item has been in inventory. Custom reports are generated at step 120. At step 122, the BI system stores information for each user with an encryption code. The user is then able to log on to the host (secure) site at step 124 using credentials provided at step 122.

Subsequent scans of RFID tags and ID markers preferably provide additional information including: product location, existing stock, turns, par levels, transfers, lost or missing inventory, as well as slow moving or dead stock. The information may be used to improve turns on stock with upcoming expiration dates and even to manage recalls, warranties, and product enhancements.

The system and process according to a preferred embodiment may also significantly reduce manual count time, allow for remote based business management, decreases time and labor, and provide accurate information for inventory and supply chain management. Further, features include, but are not limited to: the collection, extraction, and manipulation of relevant data to establish improved operational results and develop, link, and obtain intelligent strategic objectives; system flexibility to integrate multiple or new identification methodologies; system flexibility to provide custom reports and metric evaluation; unique software system which allows for integration of new product ID methodology; association of data collection and metric management with multiple supply chain management processes; evaluation of existing identification technology for optimal operational solutions; review of existing supply chain performance management processes; ability to establish hierarchy of desired metrics; financial analysis to determine impact for using pre-coded RFID with existing product markers; improve order time fulfillment, forecast accuracy, cash to cash cycle time, asset utilization, overall supply chain cost and or cost of goods (COGs), decreased shipping, labor and administrative overhead, and improved customer satisfaction; items are scanned daily upon departure of the warehouse and scanned when placed at the specified locations.

FIG. 2 illustrates in further detail, aspects of information flow for web-based system 100. Customer (such as, for example, a distribution warehouse or vendor/supplier) 202 enters SKU and location data into the system web application 204, 230. Items are shipped and received at specified locations 206, 232. A RFID scanner (reader) is connected to the Internet and information from the scanner is uploaded into the web application 208, 218. The web application populates ID data and location data at 210, 214 into the system 200 to compile reports 212, 236, 242. Reports 212 are generated thru information exchange 238. At step 216, the web application combines RFID data with existing customer ID marker information to create an unique product ID. At step 220, the customer scans tagged (RFID) and ID (bar code) into location. The system assigns the item a location, for example, in a warehouse, such as “aisle 3, shelf 2, bin 4”. At step 222 the customer tags items with RFID tags and scans RFID and customer ID marker into appropriate locations 244.

FIG. 3 depicts a system order and set-up flow diagram for a system 100 according to an embodiment of the present invention. Customer 302 Logs onto the online site 310 and enters company information and purchases system 100 at 304. The customer then logs onto the website 312 to access the customer database 306 and enters location and product information into the website. The website compiles information and sends product hardware and software to the customer 314. Customer orders product and hardware at 308 and hardware and RFID is sent to the customer 316.

FIG. 4 illustrates the association of a RFID tag with ID marker(s). Standard 3D or QR barcode marker(s) 406 and/or standard barcode markers 408 associated with a product contain product information. RFID tag 404 includes RFID information. RFID reader 402 scans and reads barcodes 406, 408 and RFID tag 404 and encodes the combined information into the database.

While the preferred embodiment of the invention has been illustrated and described, as noted above, many changes can be made without departing from the spirit and scope of the invention. As such, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for supply chain management, comprising the steps of:
Associating an RFID tag with a product;
Scanning the RFID tag and product identification marker; and,
Creating a unique product identification from information on the RFID tag.

2. The method of claim 1 further comprising the steps of
Associating a product identification marker with the product;
Scanning the product identification marker; and,
Combining the scanned information from the RFID tag and identification marker to create the unique product identification.

3. The method of claim 2, further comprising the step of storing the unique product identification in a database.

4. The method of claim 4, further comprising the step of generating a report based at least in part on the unique product identification.
